(19) United States
(12) Patent Application Publication
(10) Pub. No.: US 2006/0269331 A1
(43) Pub. Date: Nov. 30, 2006

(54) Dry ink developer station warmer for improved dry ink charge control and dry ink concentration stability

(75) Inventors: Scott T. Slattery, Brockport, NY (US); William J. Hagen, Hilton, NY (US); Peter S. Alexandrovich, Rochester, NY (US)

Correspondence Address: Mark G. Bocchetti;Patent Legal Staff, Eastman Kodak Company, 343 State Street, Rochester, NY, 14650-2201, US

(73) Assignee: Eastman Kodak Company

(21) Appl. No.: 11/138,224

(22) Filed: May 26, 2005

(51) Int. Cl. G03G 15/08

(52) U.S. Cl. 399/253

(57) ABSTRACT

A controllable dry ink developer station warmer in association with an electrographic reproduction apparatus dry ink developer station having a housing containing developer material including dry ink and carrier particles and a monitor to measure concentration of dry ink in the developer material in the developer station. The dry ink developer station warmer includes at least one heater element associated with the developer station. A control for the warmer attached to the heater element maintains the heater element at a temperature which enables developer material to remain at a substantially constant temperature and water content resulting in a more stable charge level and contributing to a more consistent charging rate for add-mixed dry ink, and keep the dry ink concentration monitor at a substantially constant temperature, whereby the effects of temperature sensitivity on the concentration monitor are substantially decreased.

### FIELD OF THE INVENTION

This invention relates in general to a dry ink developer station for an electrographic reproduction apparatus, and more particularly to a warmer for a reproduction apparatus dry ink developer station for improving dry ink charge control and dry ink concentration stability.

### BACKGROUND OF THE INVENTION

In typical commercial reproduction apparatus (electrographic copier/duplicators, printers, or the like), a latent image charge pattern is formed on a uniformly charged charge-retentive or photoconductive member having dielectric characteristics (hereinafter referred to as the dielectric support member). Pigmented marking particles (dry ink) are attracted to the latent image charge pattern to develop such image on the dielectric support member. A receiver member, such as a sheet of paper, transparency or other medium, is then brought into contact with the dielectric support member, and an electric field applied to transfer the dry ink developed image to the receiver member from the dielectric support member. After transfer, the receiver member bearing the transferred image is transported away from the dielectric support member, and the image is fixed (fused) to the receiver member by heat and pressure to form a permanent reproduction thereon.

Electrographic reproduction apparatus that use dry ink materials have historically had difficulties dealing with environmental changes. Specifically, temperature and relative humidity have a significant effect on charging rate and charge level of the dry ink. At times this can result in unacceptable voltage levels on the image-forming member in the electrographic process. Further, in order to insure optimum print quality, dry ink concentration (i.e., dry ink marking particles as a per cent of dry ink marking particles plus magnetic carrier particles) must be closely controlled. In many cases this control is accomplished through the use of a magnetic type sensor to aid in determining concentration. The sensor indicates the presence (or absence) of the magnetic component of the developer material carrier particles in the dry ink developer station, and thereby enables the dry ink concentration of the developer mixture to be calculated. Depending upon the calculated concentration, a dry ink marking particle replenisher mechanism can be activated to increase the amount of dry ink in the developer mixture, and thus adjust the dry ink concentration therein. The problem with the magnetic type of sensors is that they are inherently sensitive to temperature changes (i.e., the electrical response of a sensor varies with temperature). Therefore, the actual dry ink concentration can vary considerably during operation depending on the temperature of the sensor device and its feedback to activate the dry ink replenisher mechanism. In addition, this thermal drift of the dry ink concentration sensor output can be described as having a distribution of positive or negative thermal drift depending on the individual sensor and possibly over the life of the sensor.

It is therefore an object of the invention to provide improved dry ink charge control and dry ink concentration stability in electrographic reproduction apparatus.

### SUMMARY OF THE INVENTION

In view of the above, the purpose of this invention is provided by including a controllable station warmer in association with the electrographic reproduction apparatus dry ink developer station having a housing containing developer material including dry ink and carrier particles and a monitor to measure concentration of dry ink in the developer material in the developer station. The dry ink developer station warmer includes at least one heater element associated with the developer station. A control for the warmer attached to the heater element maintains the heater element at a temperature which enables developer material to remain at a substantially constant temperature and water content resulting in a more stable charge level and contributing to a more consistent charging rate for dry ink. Further, the warmer keep the dry ink concentration monitor at a substantially constant temperature, whereby the effects of temperature sensitivity on the concentration monitor are substantially decreased.

Since the dry ink developer station and the dry ink concentration monitor can take an appreciable time to warm from normal room temperature and the change from room temperature to operating temperature can cause changes in dry ink concentration and dry ink charge and thereby photoconductor voltages, the warmers are normally in operation at all times that the reproduction apparatus has power. This minimizes the time until first prints are able to be run and keeps the electrographic process more stable. The warmers are only turned off when the operating temperature is reached. When the temperature falls below the operating temperature, the warmers are reenergized.

### BRIEF DESCRIPTION OF THE DRAWINGS

In the detailed description of the preferred embodiments of the invention presented below, reference is made to the accompanying drawings, in which:

FIG. 1 is a schematic illustration, in cross-section, of a typical electrographic reproduction apparatus including a dry ink developer station;

FIG. 2 is a front elevational view, partly in cross-section and on an enlarged scale, of a dry ink developer station for the reproduction apparatus of FIG. 1, utilizing a controllable warmer according to this invention; and

FIG. 3 is a bottom plan view, partly in cross-section and on an enlarged scale, of a dry ink developer station for the reproduction apparatus of FIG. 1, utilizing a controllable warmer according to this invention.

### DETAILED DESCRIPTION OF THE INVENTION

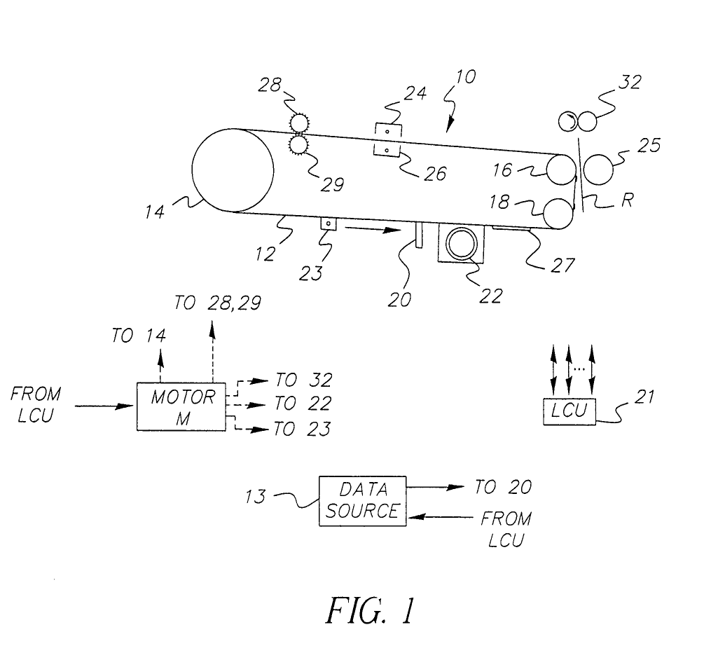

With reference to FIG. 1, an electrographic reproduction apparatus 10 includes a Primary Image-Forming Member (PIFM) such as a web 12 that is trained about transport rollers 14, 16, and 18, thereby forming an endless or continuous web. Of course, the PIFM could also be in the form of a drum. Roller 14, for example, is coupled to a drive motor M in a conventional manner which in turn is controlled for actuation by a Logic and Control Unit (LCU) 21, such that the roller 14 is driven by the motor M and moves the web 12 in a direction as indicated by arrow A. This movement of the web 12 brings the web into operative association with a charger 23 which lays down a uniform charge on the web, and then directs successive image areas of the web 12 sequentially into operative association with the direct write station 20 of the electrographic reproduction apparatus 10.

The LCU 21 may have one or more microprocessors arranged to perform arithmetic and logic operations and instruction decoding for operation of the reproduction apparatus marking engine as well as controlling the time allocation of peripherals such as a receiver sheet (paper) supply controller and accessories through a machine control communications link. Several output functions may be available for receiver sheets including selection of output trays, stapling, sorting, folding, finishing mailbox envelope receiver, etc. Programming of a number of commercially available microprocessors is a conventional skill well understood in the art. This disclosure is written to enable a programmer having ordinary skill in the art to produce an appropriate control program for the microprocessor(s). The particular details for any such program would of course, depend on the architecture of the designated microprocessor.

A data source 13 which may include a scanner, word processor, computer work station or data reader includes a memory for storing in digital form, for example a page of image data to be recorded on an image frame of the PIFM web 12. Various sensors may be provided on the apparatus as is well known, to communicate information to the LCU 21 so that various timing functions are appropriately timely enabled or deactivated as is well known in accordance with programmed control of apparatus of this type.

At the direct write station 20 digital image data from the data source 13 representing a line of pixels to be recorded is fed serially or parallel to data storage registers on an electrographic write head. The write head may include a series of electrodes that extends across the PIFM web 12 in a row transverse to the direction of movement of the web 12, or alternatively any well-known Light Emitting Device (LED) array. The write head exposes the uniform charge on the PIFM web 12 and converts the uniform charge on the web into a latent image charge pattern corresponding to the data information from the data source 13. In the manner more fully described below, dry ink is applied by, for example, a magnetic brush developer station 22 to the latent image charge pattern on the web 12 to develop the latent image into a dry ink image 27.

The developed dry ink image 27 on the PIFM web 12 is then transported to a transfer station wherein a receiver sheet R is fed in timed relationship with the image on the image frame of the PIFM web into intimate contact therewith through a nip formed by transfer roller 25 and roller 16. In the nip, an electric field is applied to provide electrostatic transfer of the dry ink image to the receiver sheet. Preferably, the transfer is electrostatic by electrically biasing roller 25 to a polarity and potential suitable for attracting dry ink from the web 12 to the receiver sheet as is well known. Corona charger transfer may also be used. The receiver sheet with the transferred image is then detached from the PIFM web 12 and transported through fusing roller assembly 32 which fix the dry ink image to the receiver sheet. The receiver sheet is then transported to a bin for storage or inverted for duplexing by a mechanism not shown for transfer of a second image to a second side of the receiver sheet.

The PIFM web 12 is then neutralized of charge on both sides by corona charging stations 24, 26 and remnant toner or dirt is cleaned at a cleaning station, which may include cleaning brushes, 28, 29 or blades and is prepared for reuse.

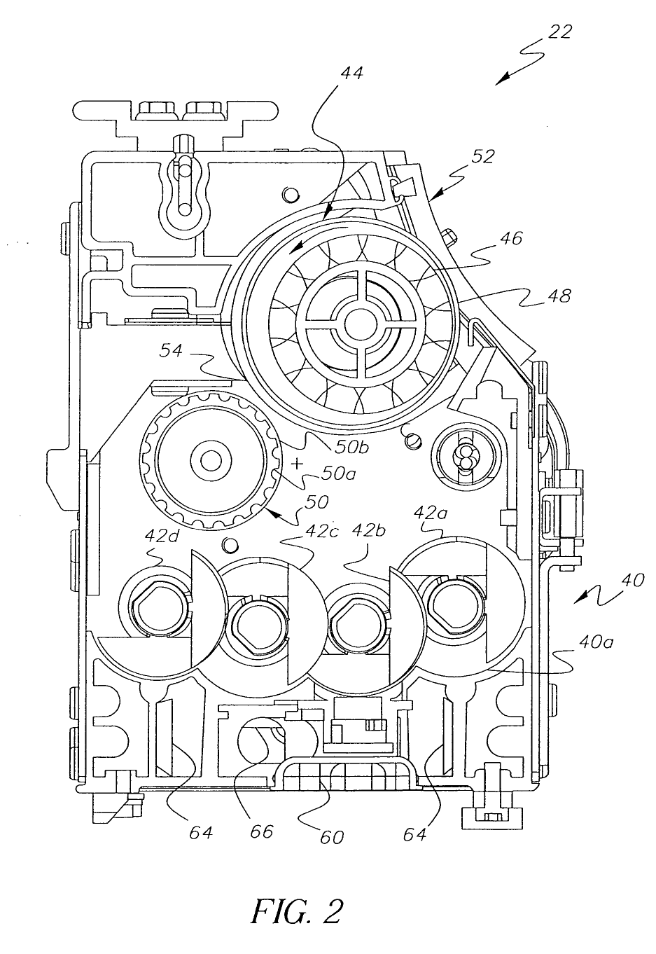

FIG. 2 shows, in greater detail and on an enlarged scale, the reproduction apparatus magnetic brush dry ink developer station 22. The magnetic brush dry ink developer station 22 includes a housing 40 forming, in part, a reservoir for developer material; i.e. pigmented marking particles (dry ink) triboelectrically attracted to ferromagnetic carrier particles. A plurality of augers 42a-42d, having suitable mixing paddles, stir the developer material within the reservoir of the housing 40 to generate the triboelectric attraction forces between the dry ink and carrier particles. A developer roller 44, mounted within the developer station housing 40, includes a rotating (counterclockwise in FIG. 2) fourteen-pole core magnet 46 inside a rotating (clockwise in FIG. 2) shell 48. Of course, the core magnet 46 and the shell 48 can have other suitable configurations and/or modes of relative rotation. Developer material is transported from the reservoir area adjacent to the mixing augers 42a-42d to the vicinity of the shell 48 by a transport assembly 50. The transport assembly includes a multi-pole magnet 50a within a rotating shell 50b to attract developer material to the shell 50b for transport to the vicinity of the developer roller shell 48.

The core magnetic 46 is positioned such that its center of rotation is not the same as the developer roller shell 48. This is done primarily to allow spent developer material to fall off the developer roller shell 48 when the material reaches a region of lower magnetic field for ready return to the developer station housing reservoir portion. This eliminates the need for a take-off skive to remove developer material from the developer roller 44, alleviating operating concerns due to toner flake and agglomerate production by a take-off skive.

The quantity of developer material delivered from the reservoir portion of the housing 40 ultimately to the image charge pattern development zone 52 is controlled by a metering skive 54, positioned parallel to the longitudinal axis of the developer roller 44, at a location upstream in the direction of shell rotation, prior to the development zone. The metering skive 54 extends the length of the developer roller 44. The core magnet 46 does not extend the entire length of the developer roller 44; as such, the developer material nap on the shell 48 does not extend to the end of the developer roller.

The magnetic brush dry ink developer station 22 provides for replenishing the housing reservoir with a fresh supply of dry ink marking particles for the developer material as required. For example, a multi-point replenishment system (not shown) allows for greater total throughput of developer material while maintaining a minimal amount of fresh dry ink being added at any one point along the length of the developer station housing 40. This allows the dry ink to be mixed into the developer material much quicker and can subsequently get triboelectrically charged much quicker. This aids in reducing dusting and maintaining a uniform concentration of marking particles throughout the sump.

The relative concentration of dry ink in the developer material is determined by a dry ink concentration monitor 60. Well-known dry ink concentration monitors are available from TDK or Hitachi. The placement of the dry ink concentration monitor 60 is such that the monitor is mounted on and through a lower extrusion 40a of the dry ink developer station housing 40, in direct contact with the developer material. As noted above, the dry ink concentration monitor 60 detects the presence (or absence) of the magnetic component of the developer material carrier particles in the dry ink developer station, and thereby enables the dry ink concentration of the developer mixture to be calculated. Depending upon the calculated concentration, a dry ink marking particle replenisher mechanism can be activated to increase the amount of dry ink in the developer mixture, and thus adjust the dry ink concentration therein. The problem with the magnetic type of sensors is that they are inherently sensitive to temperature changes (i.e., the electrical response of a sensor varies with temperature). Therefore, the actual dry ink concentration can vary considerably during operation depending on the temperature of the sensor device and its feedback to activate the dry ink replenisher mechanism. In addition, this thermal drift of the dry ink concentration sensor output can be described as having a distribution of positive or negative thermal drift depending on the individual sensor and possibly over the life of the sensor.

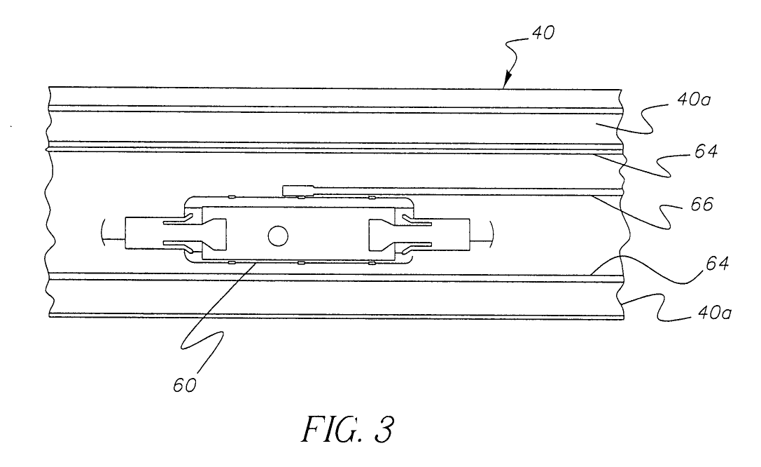

According to this invention, the temperature within the developer station housing is controlled, in the manner described below, by at least one heater element including a warmer 64 (two warmers shown in FIGS. 2 and 3). The warmers 64 are mounted in contact with the lower extrusion 40a of the developer station housing 40. The heater elements are, for example, thermofoil flexible circuits available from Minco. The flexible circuits are applied to the lower extrusion surface.

The temperature of the lower extrusion 40a is measured by a resistance temperature detector referred to as a thermister 66. The thermister 66 can be separate from the thermo foil flexible circuit warmers 64 or integral therewith. An integral arrangement would facilitate installation and reduce cost. The thermister 66 is connected to the LCU 21 (FIG. 1) and sends a signal thereto representative of the temperature of the lower extrusion 40a of the developer station housing 40. The LCU 21 can then control the warmers 64 to heat up the lower extrusion 40a.

The temperature of the lower extrusion 40a of the developer station housing 40, in the steady state condition, is directly related to the temperature of the developer material within the developer station housing. Therefore, the control of the heating of the lower extrusion 40a by the warmers 64 by the LCU 21 can maintain a substantially constant temperature within the developer station housing 40. Accordingly, the developer material in the developer station housing 40 remains at a more constant temperature and water content resulting in a more stable charge level and contributing to a more consistent charging rate for add-mixed dry ink material. Further, since on start up the dry ink developer station housing 40 and the dry ink concentration monitor 60 can take an appreciable time to warm from normal room temperature and the change from room temperature to a suitable predetermined operating temperature can cause changes in dry ink concentration and dry ink charge and thereby photoconductor voltages, the warmers 64 are normally in operation at all times that the electrographic reproduction apparatus 10 has power. This minimizes the time until first prints are able to be run and keeps the electrographic process more stable. The warmers 64 are only turned off when the predetermined operating temperature is reached. When the temperature falls below the predetermined operating temperature, the warmers are reenergized. Additionally, the warmers 64 serve to keep the dry ink concentration monitor 60 at a more constant temperature, thus decreasing the effects of temperature sensitivity on the concentration monitor output signal.

The invention has been described in detail with particular reference to certain preferred embodiments thereof, but it will be understood that variations and modifications can be effected within the spirit and scope of the invention.

### PARTS LIST

10 Electrographic reproduction apparatus
12 Web
13 Data source
14, 16, 18 Transport rollers
20 Write station
21 Logic and Control Unit (LCU)
22 Magnetic brush dry ink developer station
23 Charger
24 Charger
25 Transfer roller
26 Charger
27 Dry ink image
28, 29 Cleaning brushes
32 Fusing roller assembly
40 Housing
40a Lower extrusion
42a-42d Mixing Augers
44 Developer roller
46 Core magnet
48 Shell
50 Transport assembly
50a Multi-pole magnet
50b Shell
52 Development zone
54 Metering skive
60 Dry ink concentration monitor
64 Warmers
66 Thermister
R Receiver Sheet
M Motor

What is claimed is:

1. A controllable dry ink developer station warmer in association with an electrographic reproduction apparatus dry ink developer station having a housing containing developer material including dry ink and carrier particles and a monitor to measure concentration of dry ink in developer material in said developer station, said dry ink developer station warmer comprising:
at least one heater element associated with said developer station; and
a control for the warmer attached to said at least one heater element, said control maintaining said at least one heater element at a temperature which enables developer material to remain at a substantially constant temperature and water content resulting in a more stable charge level and contributing to a more consistent charging rate for dry ink, and keeping said dry ink concentration monitor at a substantially constant temperature, whereby the effects of temperature sensitivity on said concentration monitor are substantially decreased.

2. The dry ink developer station warmer according to claim 1, wherein said warmer includes two heater elements.

3. The dry ink developer station warmer according to claim 1, wherein said at least one heater element is a thermofoil flexible circuit attached to said developer station housing.

4. The dry ink developer station warmer according to claim 4, wherein said control further includes a thermister to measure the temperature in said developer station housing and produce a signal corresponding to such temperature.

5. The dry ink developer station warmer according to claim 4, wherein said thermister is operatively associated with said developer station housing and said thermofoil flexible circuit of said heater element.

6. The dry ink developer station warmer according to claim 4, wherein said control further includes a logic and control unit associated with said thermister and said heater element so as, in response to a signal from said thermister, controls said heater element to heat up said developer station if required.

7. In association with a dry ink developer station warmer in of an electrographic reproduction apparatus, the dry ink developer station having a housing containing developer material including dry ink and carrier particles, and a monitor to measure concentration of dry ink in developer material in said developer station, a method of operating the dry ink developer station, said method comprising the steps of:
selectively providing heat to the dry ink developer station; and
controlling the application of heat such that developer material remains at a substantially constant temperature and water content resulting in a more stable charge level and contributing to a more consistent charging rate for dry ink, and keeps said dry ink concentration monitor at a substantially constant temperature, whereby the effects of temperature sensitivity on said concentration monitor are substantially decreased.

8. The method of operating the dry ink developer station according to claim 7 wherein heat is provided during substantially all times that the reproduction apparatus has power.

9. The method of operating the dry ink developer station according to claim 8 wherein heat is turned off only when a suitable operating temperature is reached, and when the temperature falls below the operating temperature, the heat is reenergized.
